(19) United States
(12) Patent Application Publication
(10) Pub. No.: US 2023/0043218 A1
(43) Pub. Date: Feb. 9, 2023

(54) POLYCRYSTALLINE ALUMINOSILICATE CERAMIC FILAMENT NONWOVEN MATS, AND METHODS OF MAKING THE SAME

(71) Applicant: 3M INNOVATIVE PROPERTIES COMPANY, St. Paul, MN (US)

(72) Inventors: David M. Wilson, Bloomington, MN (US); William V. Chiu, Woodbury, MN (US)

(21) Appl. No.: 17/757,782

(22) PCT Filed: Dec. 18, 2020
(86) PCT No.: PCT/IB2020/062209

§ 371 Date: Jun. 21, 2022

Related U.S. Application Data
(60) Provisional application No. 62/955,266, filed on Dec. 30, 2019.

(51) Int. Cl. D04H 1/4209; D04H 1/728; D04H 1/587; D04H 1/00; D04H 1/645

(52) U.S. Cl. CPC D04H 1/4209; D04H 1/728; D04H 1/587; D04H 1/005; D04H 1/645

(57) ABSTRACT

A nonwoven article includes a plurality of electrospun polycrystalline, aluminosilicate ceramic filaments that form a cohesive nonwoven mat. Each of the aluminosilicate ceramic filaments in the mat have an average diameter of about 200 nm to about 1000 nm as determined with electron microscopy, and the aluminosilicate ceramic filaments have an average crystalline mullite content of about 15 wt % to about 80 wt %.

### BACKGROUND

Processes for producing nonwoven webs are generally characterized as continuous filament spinning processes or discontinuous fiber blowing processes.

In one continuous filament spinning process referred to herein as an electrospinning system, a charged polymer solution is fed through a fluid introduction device such as, for example, an orifice of a nozzle. The charged polymer solution is drawn (as a jet) toward a collector such as, for example, a grounded collecting target (usually a metal screen, plate, or rotating mandrel).

During the jet's travel, solvent in the polymer solution gradually evaporates, and a charged polymer filament accumulates on the grounded target. The resulting product is a nonwoven fibrous mat composed of tiny filaments with diameters between 50 nanometers (nm) and 10 microns (μm). If the grounded collection target is rotated with respect to the nozzle position, specific filament orientations (parallel alignment or a random) can be achieved.

### SUMMARY

In one aspect, the present disclosure is directed to a nonwoven article that includes a plurality of electrospun polycrystalline, aluminosilicate ceramic filaments that form a cohesive nonwoven mat. Each of the aluminosilicate ceramic filaments in the mat have an average diameter of about 200 nm to about 1000 nm as determined with electron microscopy, and the aluminosilicate ceramic filaments have an average crystalline mullite content of about 15 wt % to about 80 wt %.

In another aspect, the present disclosure is directed to a method for electrospinning a ceramic filament from an aqueous ceramic precursor sol in the presence of an electric field established between a collector surface and a jet supply orifice. The method includes forming a jet stream of the aqueous ceramic precursor sol to form aluminosilicate ceramic filaments on the collector surface, wherein the sol includes an alumina to silica ratio in the range of 60:40 to 90:10 by weight, and wherein the sol has a viscosity of less than about 1000 cP and a solids content of less than about 25%; collecting the filaments as a green nonwoven web on the collector surface;

and heating the green nonwoven web at a temperature and for a time sufficient to convert the green nonwoven web to a cohesive mat including at least one polycrystalline, aluminosilicate ceramic filament having about 15 wt % to about 80 wt % crystalline mullite. Each of the aluminosilicate ceramic filaments in the cohesive mat has an average diameter of about 200 nm to about 1000 nm as determined using electron microscopy.

These and other unexpected results and advantages are within the scope of the following illustrative Exemplary Embodiments and Examples.

### BRIEF DESCRIPTION OF THE DRAWINGS

The present disclosure may be more completely understood in consideration of the following detailed description of various embodiments of the disclosure in connection with the accompanying figures, in which:

FIG. 1 is a cross sectional view of a mounting mat reinforced in accordance with one embodiment of the present disclosure;

FIG. 2 is a schematic diagram of an embodiment of an electrospinning apparatus used in the working examples of this application.

FIG. 3 is a scanning electron microscope (SEM) photograph at 5000X of the filaments of the nonwoven mat of Example 1.

FIG. 4 is a scanning electron microscope (SEM) photograph at 50,000X of the filaments of the nonwoven mat of Example 1.

FIG. 5 is a series of photographs showing the foldability of the nonwoven mat of Example 1 and the flexibility of the ceramic filaments thereof

FIG. 6 is a scanning electron microscope (SEM) photograph at 7500X of the filaments of the nonwoven mat of Example 2.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that:

The term “adjoining” with reference to a particular layer means joined with or attached to another layer, in a position wherein the two layers are either next to (i.e., adjacent to) and directly contacting each other, or contiguous with each other but not in direct contact (i.e., there are one or more additional layers intervening between the layers).

By using terms of orientation such as “atop”, “on”, “over,” “covering”, “uppermost”, “underlying” and the like for the location of various elements in the disclosed coated articles, we refer to the relative position of an element with respect to a horizontally-disposed, upwardly-facing substrate. However, unless otherwise indicated, it is not intended that the substrate or articles should have any particular orientation in space during or after manufacture.

The terms “(co)polymer” or “(co)polymers” includes homopolymers and copolymers, as well as homopolymers or copolymers that may be formed in a miscible blend, e.g., by coextrusion or by reaction, including, e.g., transesterification. The term “copolymer” includes random, block and star (e.g. dendritic) copolymers.

By using the term “separated by” to describe the position of a layer with respect to other layers, we refer to the layer as being positioned between two other layers but not necessarily contiguous to or adjacent to either layer.

The terms “about” or “approximately” with reference to a numerical value or a shape means +/−five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “Web basis weight” is calculated from the weight of a 10 cm×10 cm web sample.

The term “Web thickness” is measured on a 10 cm×10 cm web sample using a thickness testing gauge having a tester foot with dimensions of 5 cm×12.5 cm at an applied pressure of 150 Pa.

The term “Bulk density” is the mass per unit volume of the bulk ceramic material that makes up the web, taken from the literature.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

As used in this specification and the appended embodiments, the singular forms “a”, “an”, and “the” include plural referents unless the content clearly dictates otherwise. Thus, for example, reference to fine filaments containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

Alumina-silica filaments are typically manufactured with a low crystalline mullite (3Al₂O₃-2SiO₂) content. When the filaments are heat treated at temperatures above 1200° C. where mullite crystallizes, non-woven strength and flexibility can be greatly diminished. This lack of strength and flexibility can prevent the filaments from being used at high temperatures, and also prevents the favorable properties of mullite, including thermal stability, creep resistance, chemical stability from being achieved.

Polycrystalline aluminosilicate ceramic filaments with an increased crystalline mullite content, and nonwoven webs and mats incorporating the filaments, have excellent high temperature resistance up to 1300° C., excellent acid resistance, low pressure drop when used in filtration applications, and good flexibility. Smaller diameter filaments can have even greater softness and flexibility, lower thermal conductivity in mat form, and potentially improved mechanical properties when used as a structural element in a fiber-reinforced composite. When incorporated into a nonwoven mat, polycrystalline aluminosilicate ceramic filaments with a small diameter and higher mullite content can have a wide variety of potential applications including, for example, filtration, support media, backing media, thermal insulation such as, for example, electrical vehicle battery insulation, and high temperature acoustic insulation.

In general, the present disclosure is directed to flexible polycrystalline, aluminosilicate ceramic filaments with an average diameter of about 200 nanometers (nm) to about 1000 nm and an average crystalline mullite (3Al₂O₃-2SiO₂) content of about 15 wt % to about 80 wt %. The filaments may be economically produced using an electrospinning process. The combination of a small diameter of less than about 100 um and a high crystalline mullite content provide a fired ceramic filament with excellent heat resistance, as well as softness, flexibility, durability, and resistance to breakage, and in some embodiments can also have improved thermomechanical properties (e.g., resistance to thermal creep at elevated temperatures).

A multiplicity of the small diameter, high mullite content filaments may be collected and incorporated into a green nonwoven web, which can subsequently be fired to make a cohesive ceramic mat. In some examples, which are not intended to be limiting, the ceramic mats can be used in filtration, thermal insulation, acoustic insulation, fire protection, as a mounting mat, as a gasket or a catalyst support, can be incorporated into a fiber reinforced composite as a structural element.

In a further aspect, the present disclosure describes an electrospinning method of making a nonwoven web of the small diameter, high mullite content filaments. The method includes silica particles dispersed in water, and at least one of a hydrolysable aluminum-containing compound, through at least one jet producing device (for example, an orifice in a nozzle) to produce a jet stream in the presence of an electric field established between the at least one orifice and a collector. The jet stream is directed toward the grounded collector, and ceramic filaments are formed on the collector. The filaments may be randomly oriented to form a green nonwoven web on the collector surface, or may be oriented along a predetermined direction on the collector and subsequently formed into, or incorporated into, a green nonwoven web. The green nonwoven web may then be fired to form a cohesive ceramic mat composed of the filaments having an average diameter of about 200 nm to about 1000 nm and an average crystalline mullite (3Al₂O₃-2SiO₂) composition of about 15 wt % to about 80 wt %.

### Polycrystalline Aluminosilicate Ceramic Nonwoven Articles

In one aspect, the present disclosure is directed to a nonwoven article, which includes a plurality of polycrystalline, aluminosilicate ceramic filaments that can be collected and entangled to form a cohesive nonwoven mat. The aluminosilicate ceramic filaments incorporated into the nonwoven article have an average diameter of about 200 nm to about 1000 nm, or about 250 nm to about 500 nm, or about 300 nm to about 400 nm as measured using electron microscopy. In some embodiments, the filaments have a substantially uniform diameter, which in this application means that the standard deviation of the filament diameter is ±20%, or ±15%, or ±10%. The ceramic filaments in the nonwoven article have an average crystalline mullite (3Al₂O₃-2SiO₂) content of at least 15 wt %, or at least 20 wt %, or at least 30 wt %, or at least 40 wt %, or at least 50 wt %, or at least 60 wt %, or at least 70 wt %, or at least 72 wt %, or at least 75 wt %, or at least 80 wt %.

In some example embodiments, which are not intended to be limiting, the ceramic filaments include about 70 wt % to about 90 wt % alumina, or about 73 wt % to about 80 wt % alumina.

Referring now to FIG. 1, a reinforced nonwoven web or mat 10 according to embodiments of the present disclosure has a first major surface 12, a second major surface 14 and a thickness (i.e., the distance between surfaces 12 and 14). The nonwoven web or mat 10 has at least a first layer 16 and optionally a second layer 18, and may include one or more additional layers (not shown in FIG. 1). Each mat layer 16 and optional mat layer 18 may include at least a portion of the substantially continuous, polycrystalline, aluminosilicate ceramic filaments 20 having an average diameter of about 200 nm to about 1000 nm, and an average mullite content of about 15 wt % to about 80 wt %.

In some exemplary embodiments, the polycrystalline, aluminosilicate ceramic fibers 20 may be incorporated into the nonwoven mat 10 in conjunction with other filaments, fibers, or non-fiber fillers. Thus, in certain exemplary embodiments, the reinforced mat 10 may include other filaments or fibers selected from alumina fibers, silica fibers, silicon carbide fibers, silicon nitride fibers, carbon fibers, glass fibers, metal fibers, alumina-phosphorous pentoxide fibers, alumina-boria-silica fibers, zirconia fibers, zirconia-alumina fibers, zirconia-silica fibers, and mixtures or combinations thereof. In some embodiments, the nonwoven mat 10 can optionally include non-fiber fillers such as aerogel or glass/ceramic bubbles, and the like.

In further exemplary embodiments, the polycrystalline aluminosilicate ceramic filaments 20 may be used in conjunction with other optional performance enhancing materials (e.g., intumescent materials or inserts, a non-intumescent insert, support meshes, binders, and the like). Suitable optional performance enhancing materials are described, for example, in U.S. Pat. Nos. 3,001,571 and 3,916,057 (Hatch et al.); U.S. Pat. Nos. 4,305,992, 4,385,135, 5,254,416 (Langer et al.); U.S. Pat. No. 5,242,871 (Hashimoto et al.); U.S. Pat. No. 5,380,580 (Rogers et al.); U.S. Pat. No. 7,261,864 B2 (Watanabe); U.S. Pat. Nos. 5,385,873 and 5,207,989 (MacNeil); and Pub. PCT App. WO 97/48889 (Sanocki et al.), the entire disclosures of each of which are incorporated herein by reference in their entireties.

In certain exemplary embodiments, the nonwoven web or mat 10 further includes an optional binder to bond together the plurality of polycrystalline, aluminosilicate ceramic filaments.

A wide variety of suitable binders may be used, including an inorganic binder, an organic binder, and combinations thereof. For example, a suitable organic binder is selected from a (meth)acrylic (co)polymer, poly(vinyl) alcohol, poly (vinyl) pyrrolidone, poly(ethylene oxide, poly(vinyl) acetate, polyolefin, polyester, and combinations thereof. In other embodiments, an inorganic binder may be selected from silica, alumina, zirconia, kaolin clay, bentonite clay, silicate, micaceous particles, and combinations thereof In some embodiments, the optional binder is substantially free of silicone materials.

The polycrystalline aluminosilicate ceramic filaments having a diameter of about 200 nm to about 1000 nm and a crystalline mullite content of about 15 wt % to about 80 wt % described herein provide a nonwoven mat with excellent flexibility. In one embodiment discussed in detail in the working examples below, which is not intended to be limiting, a generally square binder-free nonwoven mat made from the ceramic filaments was folded on itself twice to form an article of about 25% of its original size, and then compressed to 20% of its uncompressed thickness under a weight. The nonwoven mat could be folded, unfolded and compressed multiple times without damage to the ceramic filaments, which remained substantially intact and unbroken.

The ability of mats to withstand repeated flexure can also be determined using a flexural endurance tester as set forth in ASTM D2176.

Polycrystalline, Aluminosilicate Ceramic Filaments

In some exemplary embodiments of the foregoing nonwoven articles, each of the plurality of polycrystalline, aluminosilicate ceramic filaments exhibits a green diameter of about 1 μm to about 10 μm, and the filaments as-fired have an average diameter of about 200 nm to about 1000 nm, or about 300 nm to about 900 nm, or about 400 nm to about 700 nm as determined using the Filament Diameter Measurement Procedure with electron microscopy, as well as a crystalline mullite content of about 15 wt % to about 80 wt %.

In further exemplary embodiments, the polycrystalline aluminosilicate ceramic filaments have a length of at least 3 mm, 4 mm, 5 mm, 6 mm, 7, mm, 8 mm, 9 mm, or even 10 mm or longer. In some such exemplary embodiments, each of the polycrystalline aluminosilicate ceramic filaments is substantially continuous, which in this application means that the filaments, while having opposing ends or termination points, nevertheless behave as continuous filaments with respect to their processing characteristics and handleability. Substantially continuous filaments typically have a length greater than 25 mm, 50 mm, 75 mm, 100 mm, 250 mm, 500 mm, 750 mm, or even longer, and may have an infinite length, or a length less than 10,000 mm, 7,500 mm, 5,000 mm, 2,500 mm, 1,000 mm, or even 900 mm. Thus, in certain exemplary embodiments, the plurality of polycrystalline, aluminosilicate ceramic filaments may have lengths of from 25 mm to at infinite length, or about 50 mm to about 10,000 mm, or about 100 mm to about 7500 mm, or about 250 mm to about 5000 mm, or even about 500 mm to about 2500 mm.

In further exemplary embodiments, the bulk density of the cohesive mat formed from the filaments may range from 0.05 to 0.3 g/cm³, 0.06 to 0.25 g/cm³, or even 0.07 to 0.2 g/cm³.

In some exemplary embodiments, the thickness of the nonwoven web and/or cohesive mat formed from the filaments is at least 0.01 mm, 0.1 mm, 1 mm, 2 mm, 5 mm, 10 mm, 20 mm, or even 50 mm, or more. In some such exemplary embodiments, the thickness of the nonwoven web and/or cohesive mat is at most 100 mm, 90 mm, 80 mm, 70 mm, or even 60 mm or less.

In additional exemplary embodiments, the basis weight of the nonwoven web and/or cohesive mat formed from the filaments is at least 10 g/m² (gsm), 50 gsm, 60 gsm, 70 gsm, 80 gsm, 90 gsm, 100 gsm, or even higher. In some such exemplary embodiments, the basis weight is no more than 4,000 gsm, 3,000 gsm, 2,000 gsm, 1,000 gsm, 750 gsm, 500 gsm, 250 gsm, or even lower.

In some exemplary embodiments, the polycrystalline aluminosilicate ceramic filaments have an alumina to silica ratio in the range of 60:40 to 90:10 by weight, or 70:30 to 80:20 by weight, 73:27 to 78:22 by weight, or even 75:25 to 77:23 by weight.

### Articles Including Polycrystalline, Aluminosilicate Ceramic Nonwoven Mats

In another aspect, the present disclosure describes an article including the foregoing nonwoven aluminosilicate cohesive ceramic web having a multiplicity of polycrystalline, aluminosilicate ceramic filaments formed using an electrospinning process and having an average diameter of about 200 nm to about 1000 nm, and an average crystalline mullite content of about 15 wt % to about 80 wt %. In some such embodiments, the article may be selected from a filtration article, a thermal insulation article, an acoustic insulation article, a fire protection article, a mounting mat article, a gasket article, a catalyst support article, a component of a ceramic article, and combinations thereof.

### Methods of Making Polycrystalline Ceramic Filaments and Nonwoven Mats

In another aspect, the disclosure describes an electrospinning process for making a nonwoven web including polycrystalline aluminosilicate ceramic filaments that can be fired to form a cohesive mat with at least some filaments having an average diameter of about 200 nm to about 1000 nm and an average crystalline mullite content of about 15 wt % to about 80 wt %.

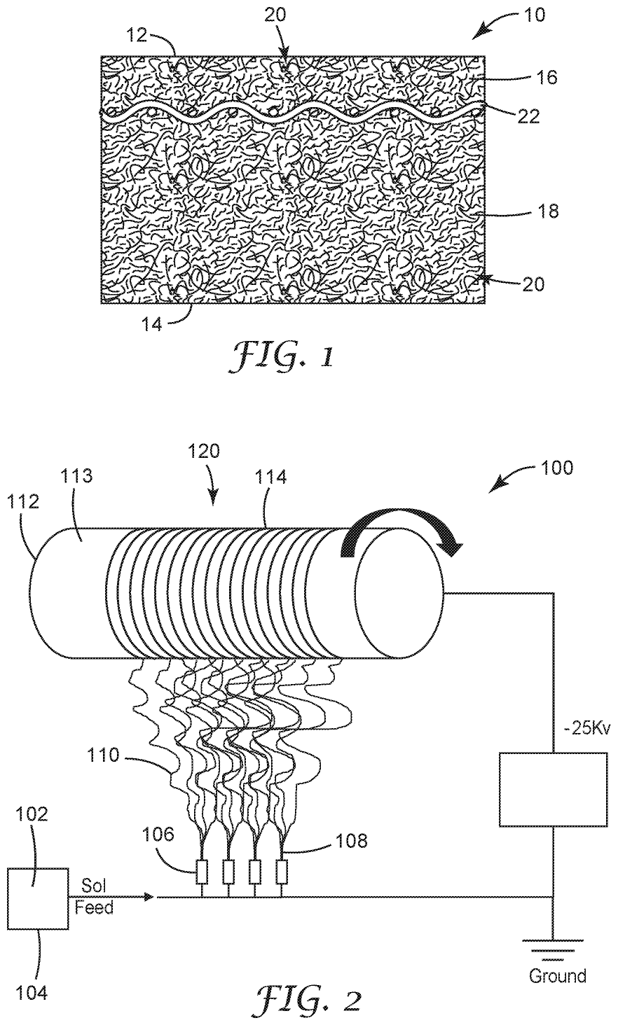

In general, as shown schematically in the diagram of an example electrospinning apparatus 100 of FIG. 2, the filaments are made by flowing an aqueous ceramic precursor sol 102 stored in a sol reservoir 104 through at least one orifice 108 in a die 106. The aqueous ceramic precursor sol 102 emerges from the orifices 108 to form filamentous jets 110. A potential difference is maintained between the orifices 108 and a rotatable collection drum 112 oriented generally normal to the stream of filamentous jets 110. The potential difference causes the elongate filamentous jets 110 to collect on a surface 113 of the drum 112 to form filaments 114.

During the travel of the jets 110 toward the surface 113, the jets move in a whipping motion and solvent in the aqueous liquid precursor sol 102 gradually evaporates. The charged filaments 114 accumulate on the grounded drum 112, and the charge on the filaments 114 eventually dissipates into the surrounding environment. If the drum 112 rotates as shown schematically in FIG. 2, in some embodiments the filaments 114 can be collected in an ordered orientation (for example, a substantially parallel alignment as shown in FIG. 2) on the surface 113. In other embodiments, the surface 113 can be a flat plate or screen, and the filaments 114 can collect in a random arrangement ono the surface 113.

The aqueous ceramic precursor sol 102 includes silica particles dispersed in water. Suitable alumina and silica sols are described, for example, in WO201893624A1 to DeRovere. The aqueous ceramic precursor sol further includes a hydrolysable aluminum-containing compound, which can have less than the stoichiometric 3 moles of anion per Al, and has the nominal formula AlXₙ(OH)₃₋ₙ, where X is a ligand such as Cl—, NO₃—, or CH₃COOH—, and is capable of forming clear aqueous solutions. These solutions can be formed using a number of methods, including dissolution of aluminum metal in salt solutions, dissolution of aluminum hydroxides in acid, hydrolysis of alkoxides, and neutralization of acidic salt solutions. In some embodiments, soluble aluminum compounds used for making filaments contain about 0.5 to about 2 moles of anion ligand per mole of aluminum. In certain embodiments, the aqueous ceramic precursor sol includes aluminum chlorohydrate and dispersed silica particles.

Optionally, the aqueous ceramic precursor sol further includes at least one of a water soluble (co)polymer and a defoamer.

In some embodiments, the water soluble (co)polymer can modify the stretchability of the composition as the composition emerges from the orifice to form a filamentous jet. Any suitable water soluble (co)polymer may be used. However, poly(vinyl) alcohol (PVA), poly(vinyl) alcohol-co-poly(vinyl) acetate copolymers, poly(vinyl) pyrrolidone, poly(ethylene oxide), and poly(ethylene oxide)-co-(propylene oxide) copolymers, have been found to be particularly suitable.

In some exemplary embodiments, the aqueous ceramic precursor sol 102 has an alumina to silica ratio in the range of 60:40 to 90:10 by weight, or 70:30 to 80:20 by weight, 73:27 to 78:22 by weight, or even 75:25 to 77:23 by weight.

The aqueous ceramic precursor sol 102 includes at least one compound to modify the surface tension of the aqueous ceramic precursor sol, which can facilitate the formation of the jets 110 emerging from the orifice 108. Suitable surface tension modifiers include, but are not limited to, more volatile alcohols such as methanol, ethanol, propanol, isopropyl alcohol, and the like. For example, in some cases, which are not intended to be limiting, alcohols can reduce the surface tension of the water in the aqueous ceramic precursor sol from about 72 dyne/cm to less than about 30 dyne/cm, and as such contribute to the formation of elongate filamentous jets.

The aqueous ceramic precursor sol further includes an optional defoamer, which may be used as the surface tension modifier, or in addition to the surface tension modifier. Any suitable defoamer may be used. In some embodiments, when medium degrees of hydrolysis (e.g., 50-90% poly(vinyl) acetate) poly(vinyl) alcohol-co-poly(vinyl) acetate copolymers are used, defoamers based on long chain alcohols like 1-octanol, and polyol esters such as the FOAM-A-TAC series of antifoams available from Enterprise Specialty Products Inc. (Laurens, SC), for example, FOAM-A-TAC 402, 407, and 425.

In some cases, aqueous ceramic precursor 102 sols used in the electrospinning process 100 should have lower viscosity than in other filament forming methods so that the liquid jets 110 can form more readily. If viscosity is too high, liquid droplets can dry in the orifices and fiber jets 110 may not readily form. In some embodiments, which are not intended to be limiting, the aqueous ceramic precursor sol 102 has a viscosity of less than about 1000 centipoise (cP), or less than about 500 cP (1 Pa-sec to about 0.5 Pa-sec), or less than about 200 cP (0.2 Pa-sec), or less than about 100 cP (0.1 Pa-sec), or about 100 to about 200 cP (0.1 Pa-sec to 0.2 Pa-sec).

In some cases, adjusting the solids content of the aqueous ceramic precursor sol 102 can facilitate the formation of smaller diameter liquid jets 110, which in turn form smaller diameter filaments 114. In various embodiments, the aqueous ceramic precursor sol 102 should have a solids content of less than about 25%, or less than about 20%, or less than about 18%, or about 15%.

In some embodiments, which are not intended to be limiting, the aqueous ceramic precursor sol 102 is supplied to the dies 106 at a pressure of about 2 psi to about 20 psi (14 Pa to 138 Pa), or about 3 psi to about 15 psi (14 Pa to 103 Pa), or at about 5 psi to about 10 psi (34 Pa to 69 Pa). Higher pressures increase sol flow rate per orifice, and in some embodiments higher pressures may also increase filament diameter.

In some exemplary methods, die 106 includes a plurality of conical nozzles with substantially circular orifices 108 positioned in a multi-orifice die in flow communication with the source 104 of the aqueous ceramic precursor sol 102.

In various embodiments, the filaments 114 collected on the drum 112 can be entangled to form a green nonwoven web 120, or can be further processed to form the green nonwoven web (not shown in FIG. 2).

In one embodiment (not shown in FIG. 2), the green nonwoven web 120 is heated (e.g., fired) at a temperature and for a time sufficient to convert the nonwoven web to a cohesive ceramic mat having incorporated therein polycrystalline, aluminosilicate ceramic filaments having an average diameter of about 200 nm to about 1000 nm and an average crystalline mullite percent of about 15 wt % to about 80 wt %.

Firing of green filaments can be considered to include two distinct steps. The first is a lower temperature pre-fire (burnout) segment in which organics are removed and inorganic phases begin to form. The second is a high temperature crystallization and sintering segment where the filaments densify and high temperature crystalline phases form. The two segments can be performed separately (e.g., a pre-fire followed by cooling to room temperature before sintering) or sequentially in a continuous process (e.g., a pre-fire followed immediately by sintering without allowing the material to cool).

Mullite (3Al₂O₃-2SiO₂) is the only thermodynamically stable crystal in the alumina-silica phase diagram. Thus, mullite will crystallize in sol-gel alumina-silica filaments during heat treatment at some elevated temperature and time. In some cases, often called monophasic gels, in which alumina and silica are mixed at near-atomic level, mullite crystallizes at relatively low temperatures, typically between about 900° C. and about 1100° C. In other cases, often called diphasic gels consisting of discrete particles or regions of alumina or silica typically 10 nm to 1000 nm, the crystallization temperature is higher, for instance 1200° C. to 1400° C. or even higher. During heat treatment of diphasic gels, other phases such as transition aluminas (e.g., gamma, eta, theta, delta aluminas) may form at intermediate temperatures, commonly between 600° C. and 1000° C., and most commonly between 800° C. and 900° C.

The crystallization of sol-gel ceramic filaments to mullite often occurs over a range of temperatures, e.g. 1200° C. to 1400° C. In other words, the nucleation and growth rate of mullite crystals is kinetically slow. Furthermore, the volumetric nucleation rate of mullite is relatively low, which leads to large grains of mullite in the filament, for instance 0.2 μm to 0.5 μm or even larger. In electrospun filaments, which have diameters below 1 μm, it is important to maintain small grain size, preferably below 0.25 μm and more preferably below 0.2 μm or even below 0.1 μm in diameter. Filaments with larger grains have lower strength and flexibility, and in various embodiments the filaments of the present disclosure can have grain sizes below 0.5 μm, or below 0.3 μm, or below 0.1 μm.

To quantify the degree of conversion of the filaments to mullite, XRD powder diffraction may be used, and in some cases determining the degree of conversion is not straightforward. Mullite crystallizes from a mixture of amorphous or partially amorphous alumina and silica phases, which do not diffract x-rays. Because of this, comparing the ratio of mullite to other phases present in the filament is not a good measure of the volume fraction of mullite in the filaments. Therefore, determining the amount of mullite in filaments is best done by comparing the size of a mullite XRD peak, e.g. at 15° or 26° 20, of the tested sample is compared to a reference sample or samples. As an example, a filament fired at 1500° C. for 1 hour may be considered to be 100% converted to mullite, and the size of the peak in an unknown sample may be compared with the size of the same XRD peak in the 1500° C. sample.

In one embodiment (not shown in FIG. 2), the green nonwoven web 120 is heated (e.g., fired) at a temperature and for a time sufficient to convert the nonwoven web to a cohesive mat having incorporated therein polycrystalline, aluminosilicate ceramic filaments having an average mullite percent of about 15 wt % to about 80 wt %. In general, the green nonwoven web 120 should be heated to a firing temperature of at least 1,000° C., 1,250° C., 1,500° C., or even higher temperature. Higher firing temperatures may result in shorter firing times, and conversely, longer firing times may permit use of lower firing temperatures. In general, the firing time should be at least 30 minutes, 1 hour, 2 hours, 4 hours, 5 hours, 7.5 hours, 10 hours, or even longer. In general, the firing time should be less than 24 hours, less than 20 hours, less than 15 hours, less than 12 hours, or even 10 hours. Suitable firing furnaces (i.e., kilns) are well known to those skilled in the art, for example, the continuous kilns manufactured by HED International, Inc. (Ringoes, NJ).

### Optional Processing Steps

Certain optional processing steps may be found advantageous in practicing various exemplary embodiments of the present disclosure. For example, the cohesive ceramic mats may be subjected to at least one of needle-punching, stitch-bonding, hydro-entangling, binder impregnation, and chopping of the cohesive mat into discrete fibers.

Thus, in one currently contemplated exemplary embodiment, the cohesive mat may be chopped to produce a plurality of discrete, polycrystalline, aluminosilicate ceramic fibers, each having an average diameter of about 200 nm to about 1000 nm and a crystalline mullite content of about 15 wt % to about 80 wt %. The resulting chopped fibers may then be further processed, for example, using at least one of wet-laying or air-laying, to form a fibrous ceramic mat including discrete aluminosilicate ceramic fibers.

Embodiments of fibrous nonwoven mounting mats described herein can be made, for example, by feeding chopped, individualized fibers (e.g., about 2.5 cm to about 5 cm in length) into a lickerin roll equipped with pins such as that available from Laroche (Cours la ville, France) and/or conventional web-forming machines commercially available, for example, under the trade designation “RANDO WEBBER” from Rando Machine Corp. (Macedon, N.Y); “DAN WEB” from ScanWeb Co. (Denmark), wherein the fibers are drawn onto a wire screen or mesh belt (e.g., a metal or nylon belt). If a “DAN WEB”-type web-forming machine is used, the fibers are preferably individualized using a hammer mill and then a blower. To facilitate ease of handling of the mat, the mat can be formed on or placed on a scrim.

Embodiments of fibrous nonwoven mounting mats described herein can be also made, for example, using conventional wet-forming or textile carding. For wet forming processes, the fiber length is often from about 0.5 cm to about 6 cm.

In some exemplary embodiments, particularly with wet forming processes, a binder may be advantageously used to facilitate formation of the mat. In some embodiments, nonwoven mats described herein comprise not greater than 10 (in some embodiments not greater than 4, 3, 2, 1, 0.75, 0.5, 0.25, or even not greater than 0.1) percent by weight binder, based on the total weight of the mat, while others contain no binder.

Optionally, some embodiments of fibrous nonwoven mounting mat described herein are needle-punched (i.e., where there is physical entanglement of fibers provided by multiple full or partial (in some embodiments, full) penetration of the mat, for example, by barbed needles). The nonwoven mat can be needle punched using a conventional needle punching apparatus (e.g., a needle puncher commercially available, for example, under the trade designation “DILO” from Dilo Gmbh (Germany), with barbed needles commercially available, for example, from Foster Needle Company, Inc. (Manitowoc, Wis.) or Groz-Beckert Group (Germany), to provide a needle-punched, nonwoven mat.

Needle punching, which provides entanglement of the fibers, typically involves compressing the mat and then punching and drawing barbed needles through the mat. The efficacy of the physical entanglement of the fibers during needle punching is generally improved when the polymeric and/or bi-component organic fibers previously mentioned are included in the mat construction. The improved entanglement can further increase tensile strength and improve handling of the nonwoven mat. The optimum number of needle punches per area of mat will vary depending on the particular application.

Typically, the nonwoven mat is needle punched to provide about 5 to about 60 needle punches/cm² (in some embodiments, about 10 to about 20 needle punches/cm². Optionally, some embodiments of mounting mat described herein are stitchbonded using conventional techniques (see e.g., U.S. Pat. No. 4,181,514 (Lefkowitz et al.), the disclosure of which is incorporated herein by reference for its teaching of stitchbonding nonwoven mats).

Typically, the mat is stitchbonded with organic thread. A thin layer of an organic or inorganic sheet material can be placed on either or both sides of the mat during stitchbonding to prevent or minimize the threads from cutting through the mat. If it is desirable for the stitching thread to not decompose in use, an inorganic thread, (e.g., ceramic or metal (such as stainless steel) can be used. The spacing of the stitches is usually about 3 mm to about 30 mm so that the fibers are uniformly compressed throughout the entire area of the mat.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Summary of Materials

Unless otherwise noted, all parts, percentages, ratios, etc. in the Examples and the rest of the specification are by weight. Solvents and other reagents used may be obtained from Sigma-Aldrich Chemical Company (Milwaukee, WI) unless otherwise noted. In addition, Table 1 provides abbreviations and a source for all materials used in the Examples below:

TABLE 1
Materials

| Name | Description | Source |
|---|---|---|
| DelPAC XG | Al₂(OH)₅Cl, aluminum | USALCO, LLC, |
| | chlorohydrate (ACH, | Baltimore, MD |
| | 22.17% A1₂O₃) | |
| Nalco 1034A | 35.60% Aqueous | Nalco Corp., |
| | Colloidal Silica Sol | Naperville, IL |
| Selvol 523 | Polyvinyl Alcohol | Sekisui Specialty |
| | | Chemical, LLC, |
| | | Dallas, TX |
| Ethanol, | | Sigma-Aldrich |
| Isopropanol | | Chemical Co., |
| | | St. Louis, MO |

### Test Methods

The following test methods have been used in evaluating some of the Examples of the present disclosure.

### Mullite Content Measurement Procedure:

Powder x-ray diffraction was used to measure mullite content. Powders were analyzed with a Rigaku MiniFlex 600 diffractometer (Tokyo, Japan) using Cu K_{α} radiation. The mullite content of example materials was determined by measuring the relative peak height of the 26° 2θ mullite and comparing to the same peak after the filaments were fired to 1500° C. for 1 hour. Filaments were considered to be 100% converted to mullite in the latter condition.

### Filament Diameter Measurement Procedure:

The diameter of the ceramic filaments was determined using a Scanning Electron Microscope (Zeiss EVO Mass., Carl Zeiss Microscopy USA, Thornwood, N.Y.).

Samples were prepared by spreading representative samplings of ceramic filaments on doublestick tape attached to a SEM stub and measuring the diameters of at least 40 ceramic filaments at greater than 1000× magnification.

Images of the nonwoven ceramic mats were also captured using a Phenom Pure Scanning Electron Microscope from PhenomWorld, Eindhoven, Netherlands, at magnifications of at least 900×.

### Sol-Gel Precursor

Aluminum chlorohydrate (ACH), colloidal silica, DI water, polyvinyl alcohol (PVA), and isopropyl alcohol were mixed together and concentrated by evaporation under vacuum. As noted in Table 1 above, the ACH (DelPAC XG) was sourced from USALCO, LLC, the source of colloidal silica was Nalco 1034A, and the PVA was sourced from Sekisui Selvol 523. The ceramic composition was 76% Alumina and 24% Silica, with 10% PVA (per weight of alumina). The viscosity of the aqueous ceramic precursor sol was about 100 cP (0.1 Pa-sec) to about 200 cP (0.2 Pa-sec), and the sol had a solids content of about 18%.

### Green Filament Firing Method:

Firing of green filaments can be considered to comprise two distinct steps. The first is a lower temperature pre-fire (burnout) segment in which organics are removed and inorganic phases begin to form. The second is a high temperature crystallization and sintering segment where the filaments densify and high temperature crystalline phases form. The two segments can be performed separately (e.g., a pre-fire followed by cooling to room temperature before sintering) or sequentially in a continuous process (e.g., a pre-fire followed immediately by sintering without allow the material to cool).

Filament webs were fired in a continuous roller kiln. The mats were conveyed through the kiln by a flat array of ceramic rollers. Webs were laid on a section of woven Nextel ceramic filament belt to be conveyed through the kiln.

The roller kiln has a series of heated zones with gradually and progressively increasing temperatures, from room temperature up to a temperature sufficient to crystallize the filaments partially or completely to mullite, which is generally about 1200° C. to about 1350° C.

During this process, most organic components and chlorine (Cl) are volatilized from the filaments between 250° C. and 600° C. The rate of temperature increase is controlled, for instance to avoid degradation of the filaments as volatiles are removed and the filament converts to ceramic, shrinks, and crystallizes. It may be desirable to control the volatilization process by introducing air, steam, nitrogen or other gases to the kiln between 200° C. and 700° C. It is also desirable to exhaust the volatiles produced. In some embodiments, the kiln is also provided with exhaust ports to remove volatiles such as CO₂ and HCl. The exhaust ports also create a negative pressure within the kiln to prevent hazardous or corrosive volatiles from escaping from the kiln.

### Example 1

60 g of concentrated ACH-silica-PVA sol was diluted with 18 g DI H₂O and mixed to dissolve. 36 g isopropyl alcohol was added in 5 g increments slowly with stir bar over about 10 minutes. The ACH-silica sol had a composition 76% Al₂O₃-24% SiO₂ and was made from Aluminum Chlorohydrate (Locron, Inc.), Nalco 1034 silica sol, and polyvinyl alcohol (9 wt % solution of Poval 22-88, a high molecular weight, intermediate hydrolysis level (88-89%) polyvinyl alcohol). The amount of PVA was 10 wt % relative to Al₂O_{3.} After dilution, the viscosity of the 76:24 sol was about 100 cP (0.1 Pa-sec).

Nanofilaments were electrospun using a Nanospinner24 from Inovenso Inc., Boston, Mass. The sol was pumped at 0.15 ml/min to 12 brass syringe nozzles (0.8 mm orifice size). Process conditions were 25 kV applied voltage and 4.5 inches (11.4 cm) distance to the collector wheel, which was rotating at 150 rpm.

The filaments were fired to form filaments in a continuous kiln, heating over 54 minutes to 1285° C. with flowing steam and air. Filaments remained flexible and felt soft to the touch. SEM microscopy found that the filaments were 1000 nm (1 μm) in diameter and uniform in diameter down their length. The filaments were many centimeters long, perhaps even tens or hundreds of centimeters in length, and some filaments were essentially continuous. The relative standard deviation of diameter was 20%. There was no shot or bead-on-a-string morphology in the filaments. Filament surfaces were relatively smooth.

The crystalline mullite content of the filaments after firing was measured by powder XRD. This test compares mullite XRD peak intensity to a reference sol-gel mullite sample heated to 1500° C. for 1 hr. The 1500° C. sample has larger crystalline grains, so has more intense diffraction peaks. Therefore, “% mullite” does not represent weight or volume percent of mullite. Filaments with greater than about 10-15 wt % mullite are considered to be substantially converted to mullite.

The mullite content of the filaments after firing to 1285° C. was 11% by XRD as compared to a reference sample heated to 1500° C. for 1 hr. After heat treatment to 1300° C., % mullite increased to 59%.

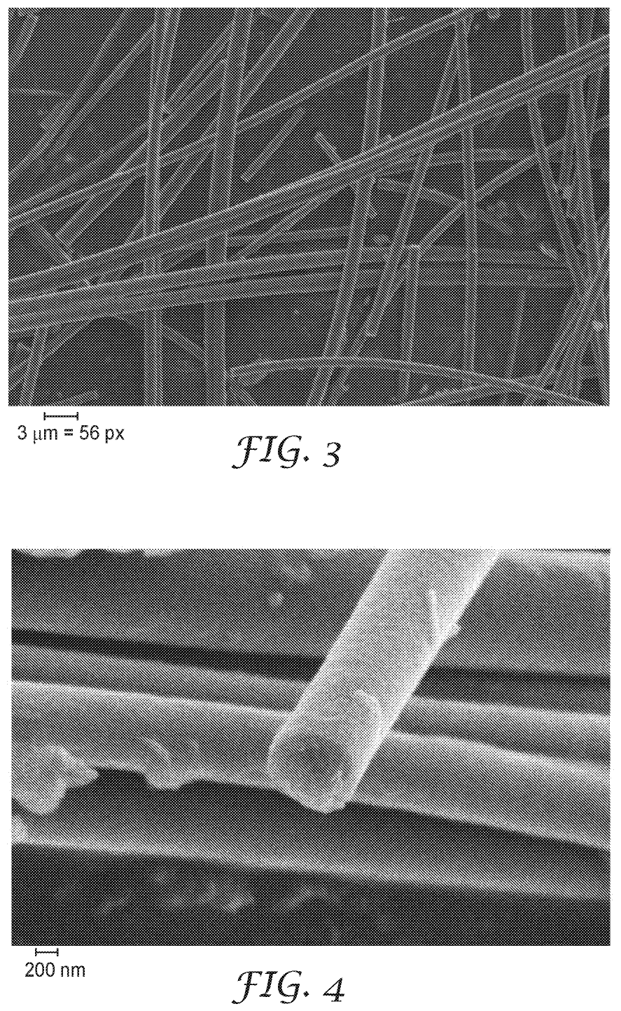

A SEM image of the nonwoven mat at 5000× magnification is shown in FIG. 3, and a SEM image of a filament of the mat at 50,000× magnification is shown in FIG. 4. The filament diameter was measured to be approximately 740 nm.

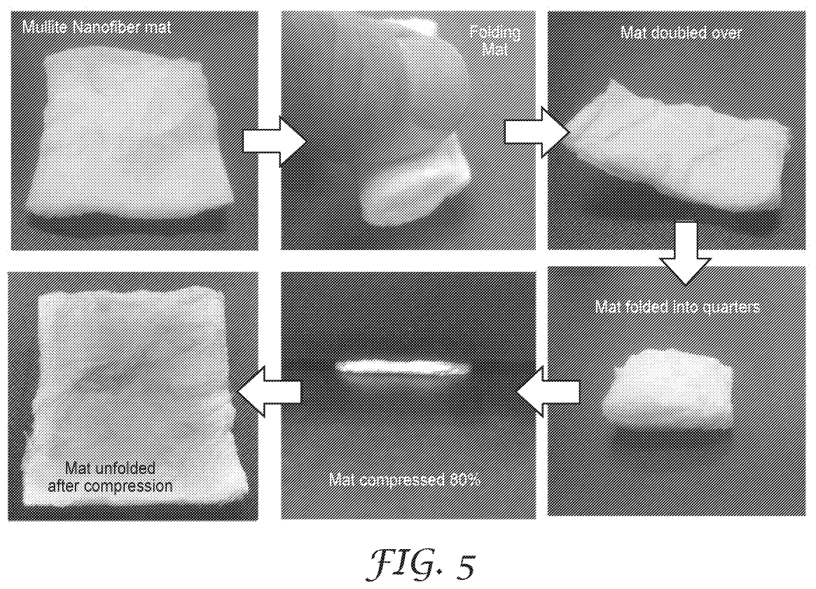

A section of nonwoven mat with basis weight 220 g/m² which had been heat treated to 1300° C. was folded into quarters and compressed to 20% of its uncompressed thickness under a 1200 gram weight. As shown in the series of photographs in FIG. 5, the nonwoven mat, which contained no organic binders, could be folded, compressed and unfolded multiple times without damage.

### Example 2

A sol with 18% ceramic solids and 10% polyvinyl alcohol per weight of alumina was made by mixing the following materials: 9g concentrated ACH-silica-PVA sol (76% Al₂O₃-24% SiO2, 35% solids); 0.47 g H2O; 2.55 g ethanol; and 5 grams isopropanol.

Electrospinning was performed as in Example 1, except that a single nozzle was used, voltage was 20kv, and the sol pump rate was 0.01 cc/min. Filaments were fired to 1285° C. as in Example 1.

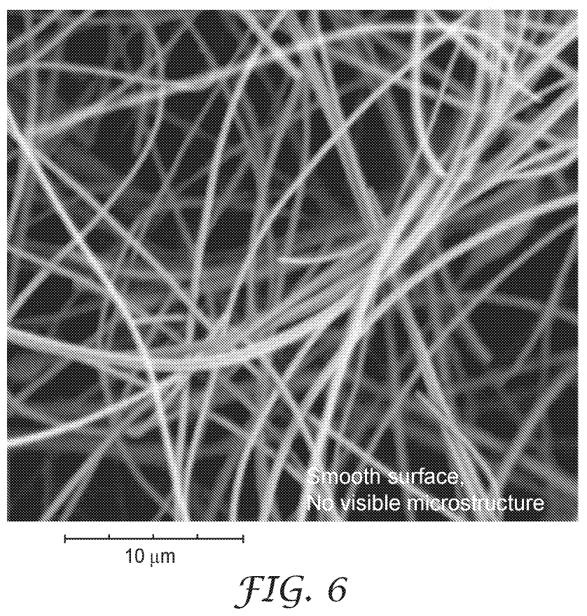

A SEM micrograph of these mullite nanofilaments is shown in FIG. 6. The filament diameter was 250 nm and was uniform down the length of each filament. The filaments were flexible, strong, and had a smooth surface.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A nonwoven article comprising a plurality of electrospun polycrystalline, aluminosilicate ceramic filaments that form a cohesive nonwoven mat, wherein each of the aluminosilicate ceramic filaments in the mat have an average diameter of about 200 nm to about 1000 nm as determined with electron microscopy, and wherein the aluminosilicate ceramic filaments have an average crystalline mullite content of about 15 wt % to about 80 wt %.

2. The nonwoven article of claim 1, wherein the aluminosilicate ceramic filaments comprise about 50 wt % to about 80 wt % crystalline mullite.

3. The nonwoven article of claim 1, wherein the nonwoven mat further comprises at least one of:
fibers selected from the group consisting of alumina fibers, silica fibers, silicon carbide fibers, silicon nitride fibers, carbon fibers, glass fibers, metal fibers, alumina-phosphorous pentoxide fibers, alumina-boria-silica fibers, zirconia fibers, zirconia-alumina fibers, zirconia-silica fibers, and mixtures or combinations thereof; and
non-fibrous materials selected from the group consisting of aerogels and glass bubbles, and mixtures or combinations thereof.

4. The nonwoven article of claim 1, wherein the plurality of polycrystalline, aluminosilicate ceramic filaments have an alumina to silica ratio in the range of 60:40 to 90:10 by weight.

5. The nonwoven article of claim 1, to wherein the plurality of polycrystalline, aluminosilicate ceramic filaments have an alumina to silica ratio of about 76:24 by weight.

6. The nonwoven article of claim 1, wherein the plurality of polycrystalline, aluminosilicate ceramic filaments comprise about 73% to about 80% alumina.

7. The nonwoven article of claim 1, wherein the nonwoven mat further comprises a binder to bond together the plurality of polycrystalline, aluminosilicate ceramic filaments.

8. The nonwoven article of claim 7, wherein the binder is chosen from a (meth)acrylic (co)polymer, poly(vinyl) alcohol, poly (vinyl) pyrrolidone, poly(ethylene oxide, poly(vinyl) acetate, polyolefin, polyester, and combinations thereof.

9. The nonwoven article of claim 7, wherein the binder is chosen from silica, alumina, zirconia, kaolin clay, bentonite clay, silicate, micaceous particles, and combinations thereof.

10. A nonwoven article of claim 1, wherein the article is selected from the group consisting of a filtration article, a thermal insulation article, an acoustic insulation article, a fire protection article, a mounting mat for a vehicle component, a gasket, a catalyst support, and combinations thereof.

11. A method for electrospinning a ceramic filament from an aqueous ceramic precursor sol in the presence of an electric field established between a collector surface and a jet supply orifice, the method comprising:
forming a jet stream of said aqueous ceramic precursor sol to form aluminosilicate ceramic filaments on the collector surface, wherein the sol comprises an alumina to silica ratio in the range of 60:40 to 90:10 by weight, and wherein the sol has a viscosity of less than about 1000 cP and a solids content of less than about 25%;
collecting the filaments as a green nonwoven web on the collector surface; and
heating the green nonwoven web at a temperature and for a time sufficient to convert the green nonwoven web to a cohesive mat comprising at least one polycrystalline, aluminosilicate ceramic filament comprising about 15 wt % to about 80 wt % crystalline mullite, wherein each of the aluminosilicate ceramic filaments in the cohesive mat has an average diameter of about 200 nm to about 1000 nm as determined using electron microscopy.

12. The method of claim 11, wherein the aqueous ceramic precursor sol comprises aluminum chlorohydrate, silica, polyvinyl alcohol (PVA), alcohol and water.

13. The method of claim 1, wherein the aqueous ceramic precursor sol further comprises a defoamer.

14. The nonwoven article of claim 11, wherein the aluminosilicate ceramic filaments have an alumina to silica ratio of about 76:24 by weight.

15. The method of claim 11, wherein aqueous ceramic precursor sol comprises about 10% PVA per weight of alumina.

16. The method of claim 11, wherein the at least one polycrystalline, aluminosilicate ceramic filaments comprise at least 70 wt % mullite.

17. The method of claim 15, wherein the polycrystalline, aluminosilicate ceramic filaments comprise about 73% to about 80% alumina.

18. The method of claim 11, further comprising at least one of needle-punching, stitch-bonding, hydro-entangling, binder impregnation, and chopping of the cohesive mat.
